(19) United States
(12) Patent Application Publication
(10) Pub. No.: US 2016/0080305 A1
(43) Pub. Date: Mar. 17, 2016

(54) IDENTIFYING LOG MESSAGES

(71) Applicant: HEWLETT-PACKARD DEVELOPMENT COMPANY, L.P., Houston, TX (US)

(72) Inventors: Eran Samuni, Yehud (IL); Daniel Adrian, Yehud (IL); Konstantin Semenchenko, Yehud (IL)

(21) Appl. No.: 14/787,452

(22) PCT Filed: Jun. 7, 2013
(86) PCT No.: PCT/US2013/044705

§ 371 Date: Oct. 27, 2015

(51) Int. Cl. H04L 12/58

(52) U.S. Cl. CPC H04L 51/26; H04L 51/24

(57) ABSTRACT

Identifying log messages can include identifying candidate log messages and calculating a score for each of the candidate log messages. Identifying log messages can include identifying a log message potentially related to an event from the candidate log messages.

### BACKGROUND

Information technology (IT) can refer to the use of computing devices to manage information. IT management can include managing a variety of areas, such as computing devices, computer software, information systems, computer hardware, and processes related thereto. To aid such management, developers of IT components may create log messages to record information.

### BRIEF DESCRIPTION OF THE DRAWINGS

FIG. 1 illustrates an example of an environment in which various examples can be implemented for identifying log messages according to the present disclosure.

FIG. 2 illustrates an example of a graphical user interface for identifying log messages according to the present disclosure.

FIG. 3A illustrates a diagram of an example of a system for identifying log messages according to the present disclosure.

FIG. 3B illustrates a diagram of an example of a computing device for identifying log messages according to the present disclosure.

FIG. 4 illustrates a flow diagram of an example of a method for identifying log messages according to the present disclosure.

### DETAILED DESCRIPTION

Information technology (IT) systems can include a number of IT components (e.g., IT devices). For example, an IT system can contain thousands of IT components including computing devices, computer software, information systems, computer hardware, network connections, and processes related thereto, such as laptops, printers, etc. Each IT component can produce log messages (e.g., data logs, event logs, security logs, error logs, etc.). Log messages can be produced periodically (e.g., during normal operation), upon occurrence of a condition (e.g., a user input), and/or when an event occurs with the IT component. As a result, hundreds of millions of log messages can be produced by the IT components.

Such log messages, while numerous, can potentially aid management of the IT components. For example, log messages may provide developers of IT component with an audit trail that can be used, for example, to understand runtime behavior of an IT component and/or facilitate diagnosis and/or troubleshooting of an event. Log messages can be, for example, automatically generated based on an event (e.g., computing error, computing failure, security threat, etc.) and may be utilized to identify the event at a later time. Manual identification (e.g., identification by IT administrators) of log messages may be limited to previously encountered events, ineffective and/or time consuming, especially in the case of evolving IT systems (e.g., updated hardware and/or software) and/or events not previously encountered.

In contrast, examples of the present disclosure include methods, systems, and computer-readable media with executable instructions stored thereon for identifying log messages. Identifying log messages can include indentifying candidate log messages, calculating a score for the candidate log messages (e.g., for each of the respective candidate log messages), indentifying a log message based on the calculated scores potentially related to an event (e.g., an indentified potential log message), and/or receiving feedback on the identified potential log message. A log message potentially related to an event refers to a log message identified for feedback (e.g., feedback indicating the identified potential log message as being non-relevant or relevant to a particular event). For instance, a user can provide an indication of relevancy that may correspond to a perceived likelihood the respective candidate log message is associated with an event.

Relevant log messages refer to log messages that can be related to a cause and/or root cause of an event. Such relevancy can be indicated by a calculated score, presence of keyword(s), and/or feedback, as described herein. For example, a comparatively higher score can be indicative of a likely correlation with a particular event. Similarly, feedback indicating the log message as relevant (e.g., “like”) can be indicative of a likely correlation with a particular event (e.g., a cause and/or a root cause of an event). Such relevant log messages may contain information that can, for example, facilitate maintenance of IT components and/or remediation of events.

An event can result in generation of log messages including information (e.g., a explanation for generation of the event) related to the event and/or can include an identifier used to identify an IT component associated with the event (e.g., generating the event). Such an identifier can include, an Internet Protocol (IP) addresses, a domain name system (DNS) name, and/or a uniform resource locator (URL), among other identifiers.

Log messages can, for example, can be stored in a data store, such as those described herein, and/or in an event archive. An event archive, for instance, can include a number of management databases (e.g., event database) and can include historical management event data. For instance, historical management event data (e.g., electronic data) can include management event data within a threshold period of time (e.g., week, month, year, etc.).

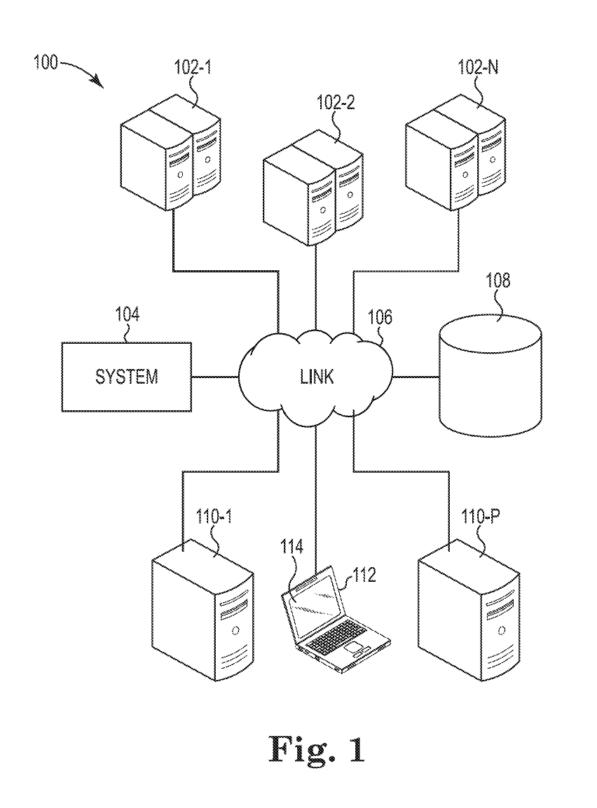

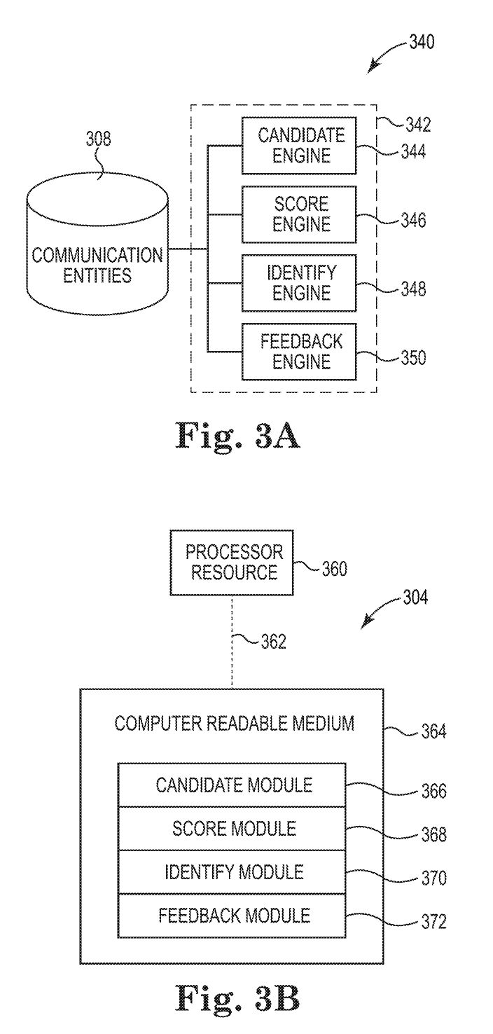

FIG. 1 illustrates an example of an environment 100 in which various examples can be implemented for identifying log messages according to the present disclosure. The environment 100 is shown to include a system to identify relevance of log messages 104, IT components 102-1, 102-2, . . . , 102-N, user devices 110-1, . . . , 110-P, a data store 108, and a link 106. The data store 108 can be analogous to those discussed with respect to FIG. 3A and/or the system 104 can be analogous to those discussed with respect to FIG. 3B. The IT components 102-1, . . . , 102-N, as described herein, can be a computing device that can respond to network requests received from the user devices 110-1, . . . , 110-P.

The user devices 110-1, . . . , 110-P represent computing devices to receive (e.g., access) stored data (e.g., electronic data) having browsers and/or other applications to communicate such data (e.g., data associated with log messages, events (e.g., reported events), and/or to receive feedback to determine relevancy (e.g., of the displayed log messages). The user devices 110-1, . . . , 110-P can include a user device 112 that includes a digital display such as a graphical user interface (GUI) 114. Similarly, in some examples, the IT components 102-1, . . . , 102-N can include a digital display (not shown) suitable for display of electronic data.

A user interface can include hardware components and/or machine-readable instruction components. For instance, hardware components can include input components (e.g., a mouse, a touch screen, and a keyboard) and/or output components (e.g., a display). An example user interface can include a GUI. A GUI can, for example, digitally represent actions and tasks available to a user through graphical icons and visual indicators. Such displays can facilitate interactions between a user and a machine (e.g., allows a user to interact with a machine using images and/or text). For example, an identified potential log message and/or a cluster representative of a plurality of log messages (e.g., including the identified potential log message) can be displayed to promote receiving feedback from a user regarding the relevancy of the identified potential log message and/or the cluster.

Link 106 (e.g., a network) represents a cable, wireless, fiber optic, or remote connection via a telecommunication link, an infrared link, a radio frequency link, and/or any other connectors or systems that provide electronic communication. That is, the link 106 can, for example, include a link to an intranet, the Internet, or a combination of both, among other communication interfaces. The link 106 can also include intermediate proxies, for example, an intermediate proxy server (not shown), routers, switches, load balancers, and the like.

The system for identifying log messages 104, as described herein, can represent different combinations of hardware and software to identify log messages. The system 104 can include the computing device 304 represented in FIG. 3B.

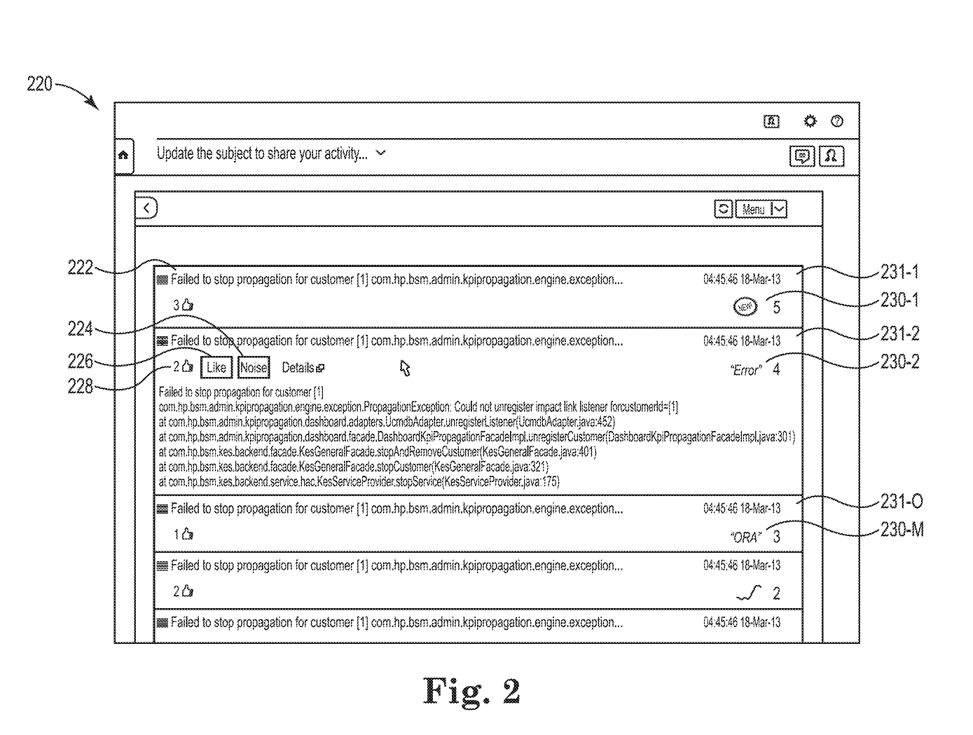

FIG. 2 illustrates an example of a GUI 220 for identifying log messages according to the present disclosure. The GUI 220 can be displayed on a display (e.g., display 114 as referenced in FIG. 1, etc.) of a user device (e.g., user device 112 as referenced in FIG. 1, etc.).

As illustrated in FIG. 2, the GUI 220 can display a log message 222. A log message 222 can include information such as an explanation for generation of the log message (e.g., does not stop propagation for customer), graphical icons for receiving feedback 224, 226, a time and/or date of generation 231-1, 231-2, . . . 231-O of the log message, and/or a status information 230-1, 230-2, . . . 230-M, among other information.

For example, the explanation can provide text, numbers, and/or symbols explaining a reason(s) for generation of the log message 222. Status information 230-1, . . . 230-M can provide an indication of history of a log message, for example indicating the number of times a given log message has been experienced (e.g., “new” corresponding to a first instance) and/or type information (e.g., error) categorizing the type of log message, among other status information.

Such an explanation can be displayed, for example, to a user who can provide feedback (e.g., indicating relevancy of a log message including the displayed explanation to an event). Feedback can, for example, be provided via graphical icons such as a relevant (e.g. “like”) icon and/or a non-relevant (e.g., “noise”) icon, among other icons. For example, feedback can be provided by a user operating an IT component directly or indirectly associated with a numerical reported in an event and/or contained in a log message. For example, the user can be operating an IT component that experiences an unexpected fault when processing a user request while using an application. In some examples, an IT administrator and/or another user (e.g., another user utilizing the application) can provide additional feedback. A total feedback received from a plurality of users (e.g., a user and an IT administrator) can be shown as a running total. Such a total can be sub-divided into respective sub-total representative of a total number of selections of respective feedback icons (e.g., a relevant total 228 and/or a non-relevant total (not shown)).

As Illustrated in FIG. 2, the GUI 220 can display a plurality of log messages including log message 222 and/or a single log message, among other information to facilitate identifying log messages. Moreover, such a display can readily enable a support personal (e.g., an IT administrator) to adjust various parameters and/or repair IT components to ensure proper functioning (e.g., accurate and/or as intended by the IT administrator).

In some examples, calculating a score can include calculating a respective sum of products of a plurality of values and a plurality of respective weighting coefficients. For example, calculating can include calculating a resultant product of the feedback value and a respective weighting coefficient (e.g., a respective weighting coefficient included in plurality of respective weighting coefficients). As shown in equation (Eq.) 1, the feedback value can be, for example, a function of feedback provided by a user and/or another user. That is, the feedback value can, in some examples, be a function (F(mⱼ), as shown in Eq. 1) of feedback provided by the user (e.g., feedback provided via the GUI 222) in response to receiving a log message identified as potentially related to an event (e.g., an identified potential log message). In some examples, another user (e.g., an IT administrator/a different user than the user initially receiving the identified potential log message) may provide feedback (e.g., additional feedback).

A user and/or another user can be in the same tenant (e.g., each using a given a databases, application, etc. associated with the IT component that generated the log message) or in different tenant. Being in the same or different tenant can, in some examples such as shown in Eq. 1, result in comparatively different feedback values being associated therewith. Such feedback provides that a user and/or another user indicating a log message is believed to be relevant to an event will receive a comparatively higher feedback value than a log message indicated to not be relevant (e.g., non-relevant) to an event.

$$F ( {m}_{j} ) = ( \begin{matrix}0 , no feedback \\ - 1000 , user indicates as nonrelevant \\ \begin{matrix}200 , another user ( same tenant ) \\ indicates as nonrelevant\end{matrix} \\ \begin{matrix}400 , another user ( different tenant ) \\ indicates as nonrelevant\end{matrix} \\ 1000 , user indicates relevant \\ 500 , another user ( same tenant ) indicates as relevant \\ 750 , another user ( different tenant ) indicates as relevant\end{matrix} ) \qquad ( Eq . 1 )$$

In some examples, the feedback value can depend on an experience level (e.g., expertise level, etc.). For example, a greater feedback value can be given for a relevancy icon selection (e.g., “like”) when the user has a relatively high experience level. The experience level of the user can be specific to the type of event that has occurred and/or can be a general experience level such as a position within an IT department. For example, a higher value can be given to feedback provided by the system administrator compared to the value given to a particular user with less experience and/or at a lower level in an IT management structure.

A calculated score for the log message 222 can, in some examples, be displayed in the GUI 220. Such a score can, for example, be a numerical information displayed within the status information 230-1, . . . , 230-M. A plurality of log messages can be sorted by a number of features including: log message template features, log message variable features, clusters, log name, a total number of occurrences of the log message, recommendation selection, among other features. For instance, in some examples, the log messages can displayed as an ordered list of a plurality of log messages potentially related to the event and can be sorted by the respective calculated score associated therewith.

In some examples, the calculated score can be based on a time of occurrence associated with each of the respective candidate log messages. As shown in Eq. 2, a time value can be, for example, a function of a time (e.g., a range of time) provided by a user. The time provided can, for example, be a range of time within which the user experienced/believes to have experienced an event. The range of time can, for example, refer to a period of time between a start time of the event (e.g., t_{b}) and an end time of the event (e.g., tⱼ). Such a start time of the event and an end time of the event can be reported by a user and/or can be reported automatically (e.g., by automated detection of an event, such as, an unexpected fault). In some examples, the range of time (t) can be the difference in time between the end time of the event and the start time of the event. Such a time can be used in calculating a time value.

As shown in Eq. 2, the time value can be, for example, be a function (T(mⱼ)) of time associated with a log message (e.g., a time of generation of the log message)(t). Such a time function provides that log messages having a time (x) associated therewith that falls within the range of time and/or comparatively near to the range of time can result in a comparatively higher time score than those times outside and/or further away from the range of time.

$$T ( {m}_{j} ) = ( \begin{matrix}\begin{matrix}1000 , time associated with log message \\ occurs during time range\end{matrix} \\ \begin{matrix}- t + x / {( t + 1 )}^{0.1} , time associated with log \\ message occurs before time range\end{matrix} \\ \begin{matrix}- t + x / {( t + 1 )}^{0.2} , time associated with log \\ message occurs after time range\end{matrix}\end{matrix} ) \qquad ( Eq . 2 )$$

In some examples, the score can be calculated based on a rate of appearance of a cluster of log messages including the identified candidate log message. A cluster of log messages refers to a group of similar log messages. For instance, generating a cluster of similar log messages can include separating a plurality of log messages into groups that all are similar (e.g., share a particular/similar pattern). For example, the separating can include comparing a number of template features and a number of variable features to determine if a particular log message has a similar pattern to a current cluster. If the particular log message has a similar pattern to the current cluster, the particular log message can be placed in the current cluster. If however, the particular log message does not have a similar pattern to the current cluster, then the particular log message can be placed into a different cluster or a new cluster cart be generated to include the particular log message.

As shown in Eq. 3, a cluster value of a given log message can be, for example, be a function of a number of appearances of a given cluster (e.g., a cluster including the given log message) during a particular time range. The time window can be the same, analogous to, or different from the range of time discussed with (Eq. 2). For instance, the time range can be a period during which observation of a particular IT component and/or IT components occurs. The time range can, in some examples, be specified by a user (e.g., provided via a GUI). Such a time range and resulting cluster value can provide that log messages from a cluster that appears once, (e.g., new log messages and/or clusters) and those appearing more often than expected (e.g., abnormally) result in a comparatively higher cluster value than those cluster values given to log messages and/or clusters that are known and/or appear as often as expected (e.g. normally).

Determining whether an appearance rate is, for example, expected can include determining a baseline appearance rate and/or identifying an amount of deviation therefrom in an observed appearance rate (e.g., an appearance rate during the time range). Such a baseline can, for example, be automatically identified based upon monitoring of an IT component(s) for a period of time prior to observation during the time range and/or can be based upon historic information associated with the IT component and/or related components. The resulting baseline can provide a comparative rate of appearance for a cluster and/or a particular log message.

$$P ( {m}_{j} ) = ( \begin{matrix}1000 , Cluster appears once , \\ 900 , Cluster apearance rate is abnormal ; \\ \begin{matrix}750 , Cluster appearance rate is \\ normal but during time range ;\end{matrix} \\ \begin{matrix}600 , Cluster appeared more than \\ once but during time range ;\end{matrix} \\ \begin{matrix}- 1000 , Cluster appearance rate is \\ normal and outside time range\end{matrix}\end{matrix} ) \qquad ( Eq . 3 )$$

The score, can in some examples, be based on an importance value associated with each of the respective candidate log messages. As shown in Eq. 4, the importance value can be function I(mⱼ) of a severity value associated with a number of keywords and/or a severity (e.g., fatal, error, warning, information, etc.,) associated with a log message. Such a severity can, for example, be associated with a log message by a developer of the IT component capable of generating the log message and/or by a user (e.g., an IT administrator).

Candidate log messages refer to log messages having a particular keyword or keywords included in the log message. For example, each candidate log message can include a keyword that matches a keyword within a list of keywords. The list of keywords can include keywords automatically generated and/or keywords provided by a user. In some examples, a candidate log message matching to a particular keyword, multiple keywords and/or having multiple instances of a keyword can be given a higher score, relative to a candidate messages not matching to the particular keyword, matching fewer keywords and/or having fewer instances of a keyword. In some examples, a score of a given log message can take into account a number, a type (e.g., user/“out of the box”), and/or a weight (e.g., assigned by an IT administrator and/or a user) associated with a keyword included in a candidate log messages. In some examples, log messages having a particular severity (e.g., fatal, error, warning, information, etc.,) associated with a log message can be identified as candidate messages. For example, a log message including a particular keyword and/or having a particular severity associated with the log message can be indentified as a candidate log message.

Such accounting for the keyword can, for example, be analogous to the importance value described with respect to Eq. 4. For instance, each keyword included in a keyword list can have a severity value associated therewith (e.g., “exception” having a severity value of “10”).

I(mⱼ)=[((severity value)*100)] (Eq. 4)

However, the disclosure is not so limited. That is, the feedback, time, cluster, and importance values described and illustrated in (Eqs. 1-4) are merely examples of such values and functions that can be used to obtain such values. The values and/or the functions therein can be altered and/or calculated using any suitable function to promote identifying log messages. Similarly, the amount of, value of, and/or equation(s) to calculate a score of a log message are merely examples and the present disclosure is not so limited. That is, any suitable amount, value, and/or function(s) can be used scores for log messages and/or to promote identifying log messages.

In some examples, calculating such a score can include calculating a respective sum of products of a plurality of values and a plurality of respective weighting coefficients. Eq. 5 illustrates such an example of an equation that can be used to calculate a score (S(nᵢ)) of a log message. For instance, the feedback, time, cluster, and/or importance values, described with respect to Eqs. 1-4, can include corresponding weighting values such as a feedback weighting coefficient (w_{f}), a time weighting coefficient (wₜ), cluster weighting coefficient (wₚ), and/or an importance weighting coefficient (wᵢ), respectively. Some or all of the respective weight coefficients can be the same or dissimilar in weight (e.g., having a numeric value representing weight such as 0.3).

S(nᵢ)=wᵢI(mⱼ)+w_{f}F(mⱼ)+wₚP(mⱼ)+wₜT(mⱼ) (Eq. 5)

1=wᵢ+w_{f}+wₚ+wₜ (Eq. 6))

The weighting coefficients (e.g., importance weighting coefficient, wᵢ) assigned to each of the plurality of values can, for example, total to one. Eq. 6 provides an example of weighting coefficients having a sum total equal to 1. For example, wᵢ can be 0.5 and a feedback weighting coefficient (w_{f}) can be 0.5 for a sum total of 1. Such a weighting coefficient can be assigned to a value and/or alter in response to receipt of the plurality of log messages and/or upon identification of the candidate log messages, among other times. The respective weights of the weighting coefficients can be determined, for example, manually (e.g., by an IT administrator) and/or automatically (e.g., in accordance with a SLA).

FIG. 3A illustrates a diagram of an example of a system 340 for identifying log messages according to the present disclosure. The environment 340 can include a data store 308 (e.g., data store 108 as referenced in FIG. 1, etc.), system for identifying log messages 342, and/or a number of engines. The system for identifying log messages 342 can be in communication with the data store 308. The system for identifying log messages 342 can include a number of engines (e.g., candidate engine 344, score engine 346, identify engine 348, feedback engine 350, etc.). The system for identifying log messages 342 can include additional or fewer engines than illustrated to perform the various functions described herein.

The number of engines can include a combination of hardware and programming to perform a number of functions described herein (e.g., identify candidate log messages from a plurality of log messages, etc.). Each of the engines can include hardware or a combination of hardware and programming instructions (e.g., MRI) designated or designed to execute a module (e.g., a particular module). The programming can include program instructions (e.g., software, firmware, etc.) stored in a memory resource (e.g., computer readable medium, machine readable medium, etc.) as well as hard-wired program (e.g., logic).

The candidate engine 344 can include hardware and/or a combination of hardware and programming to access a plurality of log messages and identify candidate log messages from the plurality of log messages. Accessing the log messages can include accessing existing log messages (e.g., previously generated and stored in the data store 108) and/or discovery of newly generated log messages (e.g., by a discovery IT component and subsequently stored in the data store 108). Generation of the log messages can occur periodically (e.g., at a regularly occurring time and/or time intervals), upon request (e.g., initiated by an IT administrator), or upon an unexpected occurrence of an event (e.g., a deviation from a performance standard, such as those specified by a SLA). The a keyword present in at least some of the plurality of log messages can be used to identify them as candidate log messages, as described herein.

The score engine 346 can include hardware and/or a combination of hardware and programming to calculate a score for the candidate log messages (e.g., for each of the respective candidate log messages). For instance, the score calculated by the score engine 346 can be based on a product of a feedback value and a feedback weighting coefficient. In some examples, the score engine 346 can calculate an increased score if the user provides feedback that the identified candidate log message is believed to be relevant to an event. Such increase score can be the result of an increased feedback value (e.g., comparatively increased compared to a feedback value associated with feedback that the identified candidate log message is non-relevant to the event).

In some examples, the score engine 346 can calculate the score based on a rate of appearance of a cluster of log messages including the identified candidate log message (e.g., as referenced in Eq. 5). The score engine 346 can, in some examples, calculate the score based on a time of occurrence associated with each of the respective candidate log messages (e.g., as referenced in Eq. 5). In some examples, the score engine 346 can calculate the score based on an importance associated with each of the respective candidate log messages. However, the present disclosure is not so limited. That is, the score engine 346 can utilize any suitable combination of values and/or weighting coefficients associated therewith to calculate a score for each of the respective candidate log message.

The identify engine 348 can include hardware and/or a combination of hardware and programming to identify a log message and/or a plurality of that log messages that can be potentially related to an event from the candidate log messages based on the calculated scores (e.g., for each of the respective candidate log messages). Such identification can, for example, include identifying the candidate log message having the comparatively highest score associated therewith.

The feedback engine 350 can include hardware and/or a combination of hardware and programming to receive feedback relating to an event relevance of the identified potential log message and/or the plurality of log messages potentially related to the event. The feedback can be provided by a user (e.g., a number of users) utilizing a GUI (e.g., GUI 220 as referenced in FIG. 2 which can be displayed on a display such as display 114 as referenced in FIG. 1, etc.). For instance, the feedback engine 350 can provide a GUI to receive feedback, from a user, relating to an event relevance of the plurality of log messages potentially related to the event. For example, the user can provide an indication of relevancy, such as relevant (e.g., provided via a “like” icon 226 as referenced in FIG. 2) and/or non-relevant (e.g., provided via a “noise” 224 icon as referenced in FIG. 2) by selecting an icon via the GUI. Such selections can be received by the feedback engine 350.

The feedback engine 350 can, for example, cause a display of an ordered list of the log messages potentially related to the event. Causing a display can include executing instructions stored in memory to directly cause a user device to display, for example, an identified potential log message and/or to communicate data with an expectation that it be processed by another device to cause the user device to display the identified potential log messages. In some examples, the instructions to cause the display includes instructions executable by the processor to cause the display of an ordered list of a plurality of log messages, each being potentially related to an event. For instance, such a display can include displaying an ordered list of the plurality of log messages ranked in order (e.g., from high to low) of score (e.g., the score as calculated by the score engine 344). In some examples, some but not all of the plurality of log messages potentially related to the event can be displayed. For example, 2 or 3 log messages can be displayed out of 10 log messages potentially related to the event. Such displays can readily enable a user to access and/or provide feedback on the relevancy of each of the displayed log messages.

FIG. 3B illustrates a diagram of an example of a computing device for identifying log messages according to the present disclosure. The computing device 304 can utilize software, hardware, firmware, and/or logic to perform a number of functions described herein.

The computing device 304 can be any combination of hardware and program instructions to share information. The hardware, for example can include a processing resource 360 and/or a memory resource 364 (e.g., computer-readable medium (CRM), machine readable medium (MRM), database, etc.) A processing resource 360, as used herein, can include any number of processors capable of executing instructions stored by a memory resource 364. Processing resource 360 may be integrated in a single device or distributed across multiple devices. The program instructions (e.g., computer-readable instructions (CRI)) can include instructions stored on the memory resource 364 and executable by the processing resource 360 to implement a desired function (e.g., identifying a candidate log message, etc.).

The memory resource 364 can be in communication with a processing resource 360. A memory resource 364, as used herein, can include any number of memory components capable of storing instructions that can be executed by processing resource 360. Such memory resource 364 can be a non-transitory CRM or MRM. Memory resource 364 may be integrated in a single device or distributed across multiple devices. Further, memory resource 364 may be fully or partially integrated in the same device as processing resource 360 or it may be separate but accessible to that device and processing resource 360. Thus, it is noted that the computing device 304 may be implemented on a user device and/or a collection of user devices, on a IT component and/or a collection of IT component, and/or on a combination of the user devices and the IT components.

The memory resource 364 can be in communication with the processing resource 360 via a communication link (e.g., path) 362. The communication link 362 can be local or remote to a machine (e.g., a computing device) associated with the processing resource 360. Examples of a local communication link 362 can include an electronic bus internal to a machine (e.g., a computing device) where the memory resource 364 is one of volatile, non-volatile, fixed, and/or removable storage medium in communication with the processing resource 360 via the electronic bus.

The memory resource 364 can include a number of modules such as a candidate module 366, a score module 368, an indentify module 370, and a feedback module 372. The number of modules 366, 368, 370, 372 can include CRI that when executed by the processing resource 360 can perform a number of functions. The number of modules 366, 368, 370, 372 can be sub-modules of other modules. For example, the candidate module 366 and the score module 342 can be sub-modules and/or contained within the same computing device. In another example, the number of modules 366, 368, 370, 372 can comprise individual modules at separate and distinct locations (e.g., CRM, etc.).

Each of the number of modules 366, 368, 370, 372 can include instructions that when executed by the processing resource 360 can function as a corresponding engine as described herein. For example, the candidate module 366 can include instructions that when executed by the processing resource 360 can function as the candidate engine 344. In another example, the feedback module 372 can include instructions that when executed by the processing resource 360 can function as the feedback engine 350. For instance, the feedback module can include MRI that when executed by the processing resource 360 can cause a display of an identified potential log message. For example, the feedback module 372 can cause a display of an order list of a plurality of log messages potentially related to the event.

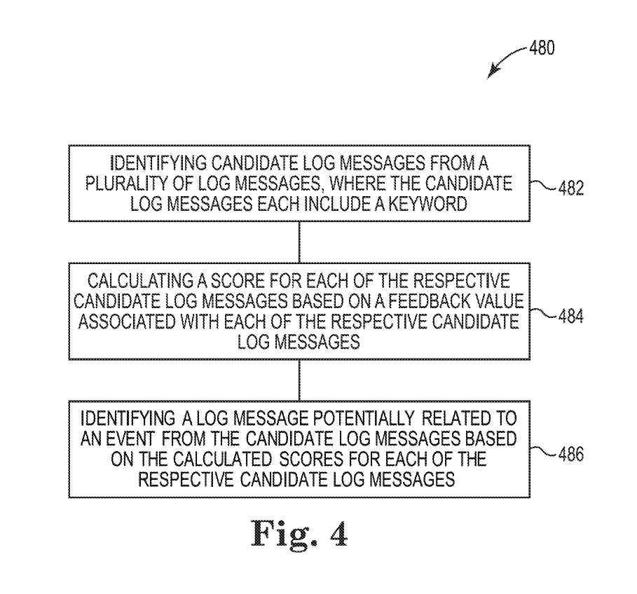

FIG. 4 illustrates a flow diagram of an example of a method 480 for identifying log messages according to the present disclosure. The example method 480 for identifying log messages can utilize a processing resource to execute instructions stored on a non-transitory medium.

For example, identifying log messages can include identifying a message potentially related to an event and/or receiving user feedback regarding the identified potential log message. For instance, log messages identified as relevant (e.g., based on user provided feedback) can be closely related to an event (e.g., a cause and/or root cause of the event). Such relevancy information can assist support staff and/or IT administrators in maintaining IT networks (e.g., IT components therein) and resolving events.

As shown at 482, the method 480 can include identifying candidate log messages from a plurality of log messages. Each candidate log message can include a keyword. That is, the candidate log message can include a keyword that matches a keyword that can be automatically generated and/or can be provided by a user. Automatic generation of keywords can include utilization of keywords provided by developers and/or manufacturers of IT components. “Out of the box” keywords can, for example, include error, warning, trace, exception, critical, fatal, minor, and/or harmless, among others. User provided keywords can be provided by a user, for example, via a GUI such as those described herein. The user provided keywords can be a particular word of interest for a user that may or may not correspond to a “out of the box” keyword. In some examples, a user can provide a weight associated with a provided keyword (e.g., 2×) to increase a score associated with log messages containing the provided keyword.

A keyword list can be generated and include “out of the box” keywords and/or user provided keywords. In some examples, the keyword included in the candidate log message can match a keyword included in a list of keywords. For instance, matching a keyword provided by a user. In some examples, matching the keyword in the candidate log message can, in some examples, include matching to multiple keywords (“out of the box” and/or user provided keywords). For example, a keyword can have severity values associated therewith. The severity value can be used in calculating an importance value, for example, as referenced in Eq. 4.

As shown at 484, the method 480 can include calculating a score for each of the respective candidate log messages. Such a score can, in some examples, be calculated as a respective sum of products of a plurality of values and a plurality of respective weighting coefficients. The score can be based on a feedback value associated with each of the respective candidate log message. In some examples, calculating a score can include calculating a feedback value that can be a function of feedback provided by a user in response to receiving a log message identified as potentially related to an event (e.g., an indentified potential log message). For instance, calculating can include calculating a product of the feedback value and a respective weighting coefficient. However, the disclosure is not so limited. That is, the score may depend upon a feedback value, a time value, a cluster value, and/or an importance value, a number of keyword matches, among other values.

As shown at block 486, the method 480 can include identifying a log message potentially related to an event from the candidate log messages based on the calculated scores for each of the respective candidate log messages. That is, in some examples, identifying the candidate log message can include identifying and/or displaying a candidate log message having a comparatively highest score assigned thereto. However, the present disclosure is not so limited. That is, there may be a plurality of log messages identified as related to a particular event, but particular log messages with a higher score can be more closely related to the cause and/or root cause of the event.

A score for each of the number of clusters can take into account the individual scores of each of the number of log messages within the particular cluster. For example, the score for each of the number of log messages can be added together in order to calculate the score for the cluster that includes the number of log messages. The score for the cluster can help determine which cluster likely includes a number of log messages that can be isolated. For example, a cluster with the highest score compared to other clusters can be determined and a number of the log messages within the cluster with the highest score can be selected and sent (e.g., displayed) to a user. The user can provide feedback on these selected number of log messages. This can lower the number of log messages that a user would have to provide feedback for and/or eliminate the user having to search through a relatively large quantity of log messages, for example, to determine log messages relevant to a particular event.

As used herein, “a” or “a number of” something can refer to one or more such things. For example, “a number of nodes” can refer to one or more nodes. As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method, comprising:
identifying candidate log messages from a plurality of log messages, wherein the candidate log messages each include a keyword;
calculating a score for each of the respective candidate log messages based on a feedback value associated with each of the respective candidate log messages; and
identifying a log message potentially related to an event from the candidate log messages based on the calculated scores for each of the respective candidate log messages.

2. The method of claim 1, wherein calculating the score includes calculating the score based on the feedback value that is a function of feedback provided by a user in response to receiving a log message identified as potentially related to an event.

3. The method of claim 1, wherein calculating the score includes:
calculating a respective sum of products of a plurality of values and a plurality of respective weighting coefficients; and
calculating a product of the feedback value and a respective weighting coefficient included in the respective weighting coefficients.

4. The method of claim 1, wherein identifying the candidate messages includes identifying the candidate messages from the plurality of log messages forming a cluster.

5. The method of claim 1, wherein the keyword included in the candidate log messages matches a keyword included in a list of keywords, the list including a keyword provided by a user.

6. Wherein identifying the log message potentially related to the event includes identifying a candidate log message of the candidate messages having a comparatively highest score assigned thereto.

7. A non-transitory machine-readable medium storing instructions executable by a processing resource to cause a computer to:
access a plurality of log messages;
identify candidate log messages from the log messages, wherein the candidate log messages each include a keyword;
calculate a score for each of the candidate log messages based on a product of a feedback value and a feedback weighting coefficient;
identify a log message potentially related to an event from the candidate log messages based on the calculated scores; and
cause a display of the identified potential log message.

8. The medium of claim 7, wherein the instructions to calculate the score include instructions executable by the processor to calculate the score based on a rate of appearance of a cluster of log messages including an identified candidate log message.

9. The medium of claim 7, wherein the instructions to calculate the score include instructions executable by the processor to calculate the score based on a time of occurrence associated with each of the respective candidate log messages.

10. The medium of claim 7, wherein the instructions to calculate the score include instructions executable by the processor to calculate the score based on an importance value associated with each of the respective candidate log messages.

11. A system, comprising a processing resource in communication with a non-transitory computer readable medium having instructions executable by the processing resource to implement a candidate engine, a score engine, an identity engine, and a feedback engine, wherein:
the candidate engine identifies candidate log messages from a plurality of log messages, wherein the candidate log messages include a log message having received feedback from a user;
the score engine calculates a score for each of the respective candidate log messages based on a product of a feedback value and a feedback weighting coefficient;
the identity engine identifies a plurality of log messages potentially related to an event from the candidate log messages based on the calculated scores for each of the respective candidate log messages; and
the feedback engine provides a graphical user interface to receive feedback, from a user, relating to an event relevance of the plurality of log messages potentially related to the event.

12. The system of claim 11, including instructions to implement the score engine to calculate an increased score if the user provides feedback that an identified potential log message is related to an event.

13. The system of claim 12, including instructions to implement the score engine to increase the score if another user provides feedback that the identified potential log message is related to the root cause.

14. The system of claim 11, wherein the feedback engine causes a display of a cluster representative of the plurality of log messages potentially related to the event.

15. The system of claim 11, wherein the feedback engine causes a display of an ordered list of the plurality of log messages potentially related to the event.
